(19) United States
(12) Patent Application Publication
(10) Pub. No.: US 2001/0048334 A1
(43) Pub. Date: Dec. 6, 2001

(54) Logarithmic amplifier

(76) Inventor: Gunnar Forsberg, Stockholm (SE)

Correspondence Address: NIXON & VANDERHYE P.C., 8th Floor, 1100 North Glebe Road, Arlington, VA, 22201, US

(21) Appl. No.: 09/774,006

(22) Filed: Jan. 31, 2001

Related U.S. Application Data
(60) Provisional application No. 60/185,178, filed on Feb. 25, 2000.

(51) Int. Cl. G06G 7/24

(52) U.S. Cl. 327/350

(57) ABSTRACT

The invention relates to a logarithmic amplifier for reading an input current (Iᵢₙ) or input voltage (Uᵢₙ) and for giving out an output voltage (Uₒᵤₜ), said logarithmic amplifier including a transistor (T1) or diode for generating logarithmic amplification, said transistor (T1) or diode including an inner serial resistance. According to the invention a compensation voltage (U_{C}) is arranged to be subtracted from the output voltage (Uₒᵤₜ) to compensate for voltage drop over the inner serial resistance.

### RELATED APPLICATION

This application claims the benefit of U.S. Provisional Application No. 60/185,178, filed Feb. 25, 2000, the entire content of which is hereby incorporated by reference in this application.

### TECHNICAL FIELD OF THE INVENTION

The present invention relates to a logarithmic amplifier.

### DESCRIPTION OF RELATED ART

It is previously known to use the logarithmic characteristics of a diode or a transistor to accomplish a logarithmic amplifier. This may be done e.g., by taking an operational amplifier and connecting the diode or transistor between the negative input and the output of the operational amplifier. A behaviour in an ordinary transistor could be that if the temperature is stable, then the voltage over the transistor increases about 60 mV when the current flowing through it increases 10 times.

However, said logarithmic characteristics are highly dependent on temperature. Firstly, the absolute value of the output voltage from the operational amplifier varies typically −2 mV/° C. Secondly, the voltage increase over the transistor due to current increase varies proportional to the absolute temperature in Kelvin.

Logarithmic amplifier circuits have been developed to compensate for the temperature dependency. A good overview of different circuits may be found in “What's All This Logarithmic Stuff, Anyhow?”, Electronic design, Jun. 14, 1999, p. 111-115.

To decrease the first temperature dependency the difference may be taken between the output voltage from the operational amplifier and a reference voltage. If said voltages have approximately the same temperature dependency, then they will be affected approximately equal from temperature changes and the difference between them will thus take away most of said temperature dependency.

Another problem is that transistors and diodes normally have an inner serial resistance, e.g., 0,5Ω, between collector and emitter or between anode and cathode, respectively. This may cause a notable error in the output voltage of the differential amplifier due to unwanted voltage drop over the inner resistance. In the case of a voltage input and a transistor this is solved in said article, FIG. 4a, by not connecting the transistor base to earth as in FIG. 3, but by connecting the base to a connection point between two resistors that are serially connected between the input voltage and ground. This pulls up the base to compensate for the voltage drop over the inner resistance. However, the compensation will not be complete, as there is also an inner resistance between the base and the emitter. Further, this only works when transistors are used and not when diodes are used and it only works with a voltage input and not with a current input.

Note that FIG. 4a in said article contains an evident error. It has to be a voltage input and not a current input, because the circuit would not work with a current input.

### SUMMARY

The problems with the solution to the voltage-drop problem in the article in Electronic Design is that it does not work very well, it does not work when diodes are used and it does not work when a current input is used.

The object of the present invention is to provide a logarithmic amplifier that solves the voltage-drop problem better and that does not have said limitations. This is solved by subtracting a compensation voltage from the output voltage of the logarithmic amplifier to compensate for the voltage drop over the inner serial resistance.

Since the compensation is made on the output and not at the transistor base the advantage is obtained that the compensation is independent of the kind of input used and of the logarithmic element used. Thus, it works as well with a current input as with a voltage input and it works as well with a diode as logarithmic element as with a transistor.

A further advantage is that the compensation voltage also may be used for other purposes, such as to provide a photodiode bias voltage in the case when the input current is produced by a photodiode. This saves money, space and time.

The invention will now be described in detail with reference to accompanying drawings. More advantages will follow from the different embodiments described.

### BRIEF DESCRIPTION OF THE DRAWINGS

FIG. 1 discloses a schematic overview of a logarithmic amplifier according to the invention.

FIG. 2 discloses an embodiment of the first differential amplifier shown in FIG. 1.

FIG. 3 discloses a first embodiment of the logarithmic amplifier in FIG. 1.

FIG. 4 discloses an embodiment of the second differential amplifier shown in FIG. 3.

FIG. 5 discloses a second embodiment of the logarithmic amplifier in FIG. 1.

FIG. 6 discloses a third embodiment of the logarithmic amplifier in FIG. 1.

FIG. 7 discloses a practical implementation of the embodiment in FIG. 6.

FIG. 8 discloses an embodiment of the inverting amplifier in FIGS. 5-7.

FIG. 9 discloses the embodiment in FIG. 6, where the input current comes from a photodiode and with an embodiment for a photodiode bias circuit.

FIG. 10 discloses an embodiment of the comparator in FIG. 9.

FIG. 11 discloses a second embodiment of the comparator in FIG. 9.

FIG. 12 discloses a second embodiment of the photodiode bias circuit.

FIG. 13 discloses a third embodiment of the photodiode bias circuit.

### DETAILED DESCRIPTION OF EMBODIMENTS

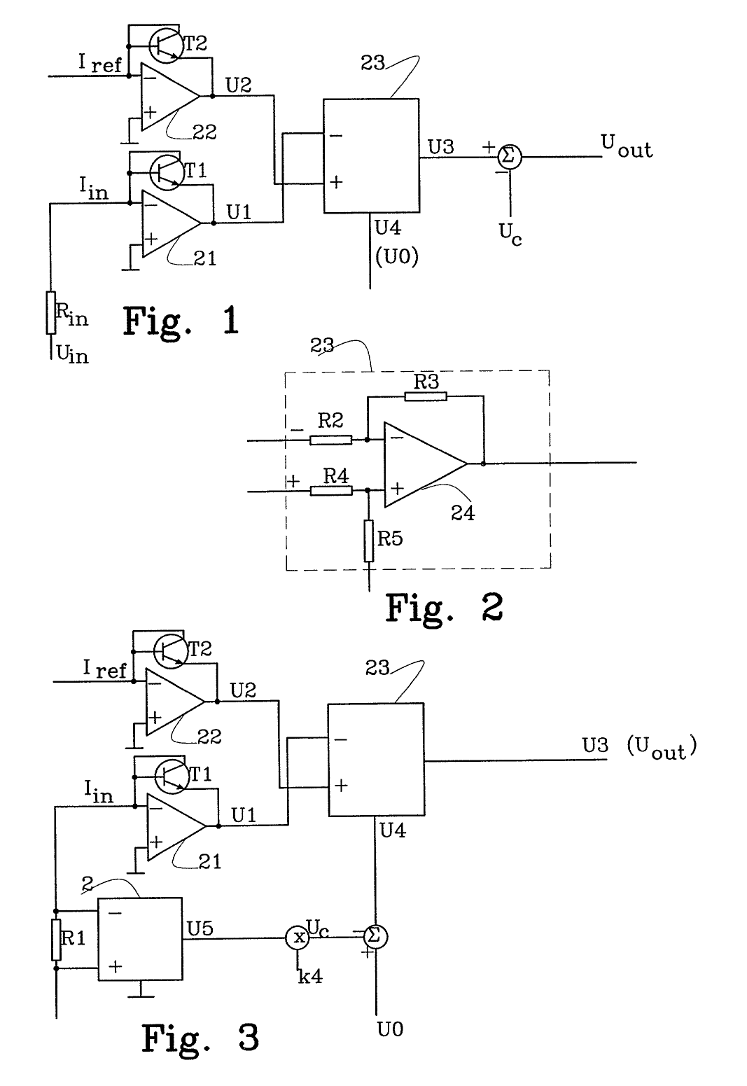

In FIG. 1 is shown a logarithmic amplifier according to the invention. An input current Iᵢₙ is fed into the negative input of a first operational amplifier 21. The positive input of the first operational amplifier 21 is connected to ground and there is a first transistor T1 connected between the negative input and the output of the first operational amplifier 21.

In FIG. 1 the first transistor T1 is connected with its collector and base to the negative input of the first operational amplifier 21 and with its emitter to the output of the first operational amplifier 21, but other connections are possible. Especially it is possible to instead connect the base to ground. It is also possible to use a diode instead of the first transistor T1. This connection of a transistor or a diode makes the output voltage of the first operational amplifier 21 a logarithmic function of the input current. Said output voltage will from now on be called the first voltage U1 for short. It is of course possible to use an input voltage Uᵢₙ together with an input resistor Rᵢₙ instead of an input current.

Since an operational amplifier has a very large input impedance the current flowing through the first transistor T1 is approximately equal to the input current Iᵢₙ. If the first transistor T1 has a first inherent temperature dependent constant k1, then the first voltage U1 will become:

U1=−k1·ln(Iᵢₙ/I₀₁) (1)

where I₀₁ is the reverse leakage current for the first transistor T1. The formula applies only approximately and only for currents that are not very small or large.

As an example, when the first transistor T1 is connected as in FIG. 1, a behaviour in an ordinary transistor with a first constant k1 of 0.06 V and a reverse leakage current I₀₁ of 10⁻¹³ A could be that if the temperature is stable, then the voltage over the first transistor T1 increases about 60 mV when the current flowing through it increases 10 times, which in this case corresponds to an increase in optical power of 10 dB.

This alone makes up a logarithmic amplifier, however very temperature dependent. Firstly, the output voltage from the first operational amplifier 21 varies typically −2 mV/° C. Secondly, the voltage increase due to current increase over the first transistor T1 varies proportional to the absolute temperature in Kelvin.

To decrease the first temperature dependency the difference is taken between the first voltage U1 and a second voltage U2 that is used as a reference. If the second voltage U2 have approximately the same temperature dependency as the first voltage U1, then they will be affected approximately equal from temperature changes and the difference between them will thus take away most of said temperature dependency.

The second voltage U2 may be accomplished by using a reference current I_{ref}, which enters the negative input of a second operational amplifier 22 that has a second transistor or diode T2 connected in the same way as the first operational amplifier 21 has. The second voltage U2 is taken from the output of the second operational amplifier 22 and is thus a logarithmic function of the reference current I_{ref}. If the second transistor T2 has a second inherent temperature dependent constant k2, then the second voltage U2 becomes:

U2=−k2·ln(I_{ref}/I₀₂) (2)

where I₀₂ is the reverse leakage current for the second transistor T2. The second constant k2 will have a value that is very close to the first constant k1. The same comments as for formula (1) apply.

It is appropriate to chose the reference current I_{ref} in the middle of the interval where measuring is intended. This is because the measuring error due to temperature dependence will be smaller the closer the input current Iᵢₙ is to the reference current I_{ref}. Thus, if it is a wish to measure input currents from 0,1 μA to 1 mA it is appropriate that the reference current I_{ref} is approximately 10 μA.

Further, the easiest way of implementing this circuit is to chose transistors T1 and T2 that have similar temperature characteristics and place them close together, so as to keep them in the same temperature.

The first voltage U1 and the second voltage U2 enters a first differential amplifier 23, which gives out a third voltage U3. Optionally, a fourth voltage U4 may be entered into the first differential amplifier if there is a wish to level adjust the interval within which the third voltage U3 may be. The fourth voltage U4 may be the same as a level adjust voltage U0 or something else. The level adjust voltage U0 may be ground, but it may also be used to displace the whole voltage interval used. This applies to all places where the level adjust voltage U0 is used.

The third voltage U3 may then be used as the output voltage Uₒᵤₜ directly or via other circuits. If the second differential amplifier has a third inherent constant k3, then the third voltage U3 will become:

U3=(U2−U1)·k3+U4 (3)

U3=[k1·ln(Iₚ/I₀₁)−k2·ln(I_{ref}/I₀₂)]·k3+U4 (4)

A problem with transistors and diodes is that they normally have an inner serial resistance, e.g., 0,5Ω, which causes a notable error for currents larger than approximately 0,1 mA. This may be compensated by subtracting a compensation voltage U_{C} from the output voltage Uₒᵤₜ, which is disclosed schematically in FIG. 1.

In FIG. 2 is shown an example on how the first differential amplifier 23 may look. The main part includes a third operational amplifier 24 with a positive input, a negative input and an output, which gives out the third voltage U3. A second resistor R2 is connected between the negative input of the first differential amplifier 23 and the negative input of the third operational amplifier 24. A third resistor R3 is connected between the negative input of the third operational amplifier 24 and the output of the third operational amplifier 24. A fourth resistor R4 is connected between the positive input of the first differential amplifier 23 and the positive input of the third operational amplifier 24. A fifth resistor R5 is connected between the positive input of the third operational amplifier 24 and the fourth voltage U4.

It is normal to choose the resistances so that the second resistor R2 and the fourth resistor R4 are equal, and so that the third resistor R3 and the fifth resistor R5 are equal. In this case the third voltage U3 may be written as:

U3=(U2−U1)·R3/R2+U4 (5)

Thus making:

k3=R3/R2 (6)

The compensation voltage U_{C} should be proportional to the input current Iᵢₙ and when there is no input current Iᵢₙ, then the compensation voltage U_{C} should be equal to zero. This can be accomplished in practice in many ways. An example is shown schematically in FIG. 3. Since the third voltage U3 is level adjusted by the fourth voltage U4, see (3), said fourth voltage U4 may be used to correct the third voltage U3 and thus the output voltage Uₒᵤₜ by taking:

U4=U0−U_{C} (7)

Thus, the third voltage U3 becomes:

U3=(U2−U1)·k3+U0−U_{C} (8)

To accomplish the compensation voltage U_{C} the input current Iᵢₙ is transformed to a voltage. This is done by using a first resistor R1 through which the input current Iᵢₙ flows. A second differential amplifier 2 or similar is connected with its negative input to one end of the first resistor R1 and with its positive input connected to the other end of the first resistor R1. Thus, the second differential amplifier reads a voltage Iᵢₙ·R1 over the first resistor R1. The second differential amplifier 2 gives out a fifth voltage U5, which is proportional to the photocurrent Iₚ. The fifth voltage U5 may be used as the compensation voltage U_{C} directly or after multiplication with a fourth constant k4.

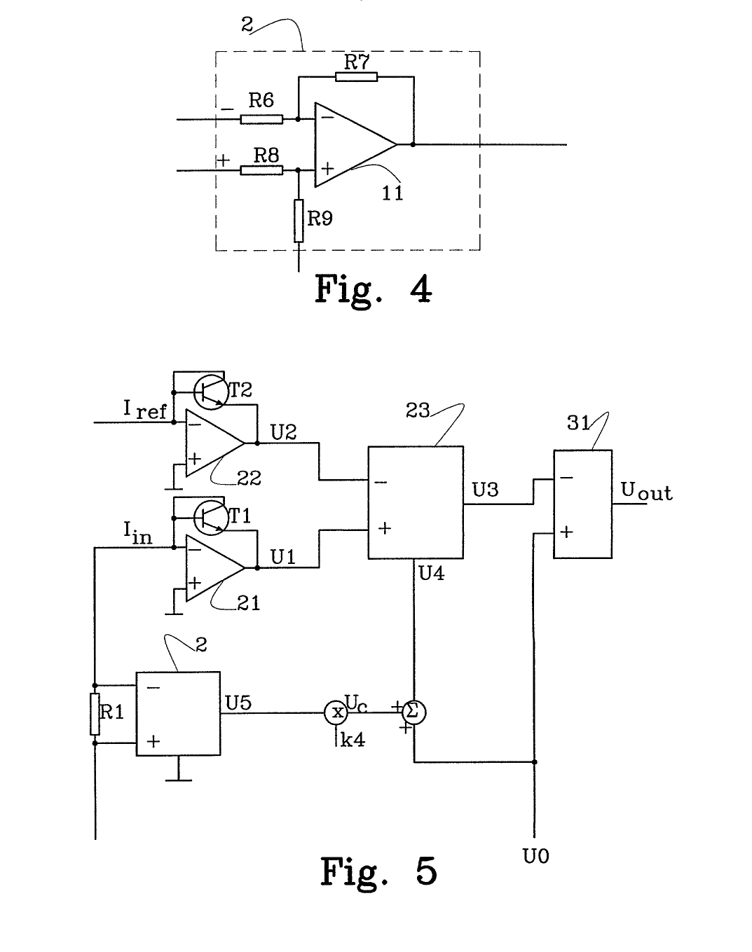

In FIG. 4 is shown an example on how the second differential amplifier 2 may look. The main part includes a fourth operational amplifier 11 with a positive input, a negative input and an output, which gives out the fifth voltage U5. A sixth resistor R6 is connected between the negative input of the second differential amplifier 2 and the negative input of the fourth operational amplifier 11. A seventh resistor R7 is connected between the negative input of the fourth operational amplifier 11 and the output of the fourth operational amplifier 11. An eighth resistor R8 is connected between the positive input of the second differential amplifier 2 and the positive input of the fourth operational amplifier 11. A ninth resistor R9 is connected between the positive input of the fourth operational amplifier 11 and ground.

It is normal to choose the resistances so that the sixth resistor R6 and the eighth resistor R8 are equal, and so that the seventh resistor R7 and the ninth resistor R9 are equal. If the resistance of the first resistance R1 is much smaller than the other resistances then the fifth voltage U5 may be written as:

U5=(R1·Iᵢₙ)·R7/R6 (9)

This is a simplified reasoning. In practice, when the second differential amplifier 2 is to be used in the circuit in FIG. 3, then the eighth resistor R8 should be complemented with some other resistors to compensate for the resistive influence from the first resistor R1.

The compensation voltage can thus be accomplished by:

U_{C}=U5·k4=R1·R7/R6·k4Iᵢₙ (10)

An alternative solution to FIG. 3 is to put an inverting amplifier 31 on the output of the first differential amplifier 23, see FIG. 5, thus making the output voltage Uₒᵤₜ the inverse of the third voltage U3 according to:

Uₒᵤₜ=(U3−U0)·k5+U0 (11)

where k5 is a fifth constant inherent in the inverting amplifier 31. This means that the compensation voltage U_{C} may instead be added to the level adjust voltage U0. To make the output voltage Uₒᵤₜ correct, the inputs to the first differential amplifier 23 should switch place and the result will then become:

U4=U0+U_{C} (12)

U3=(U1−U2)·k3+U4 (13)

Uₒᵤₜ=(U0−U3)·k4+U0=(U2−U1)·k3·k4+U0−U_{C}·k4 (14)

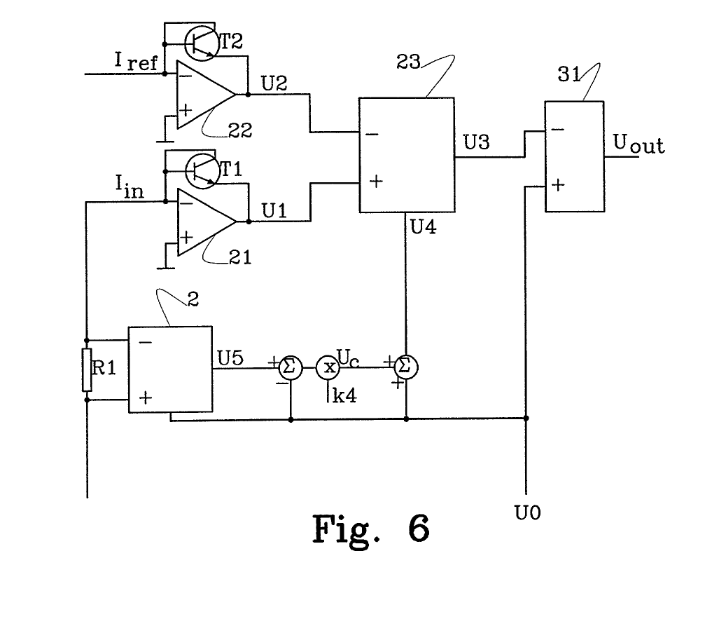

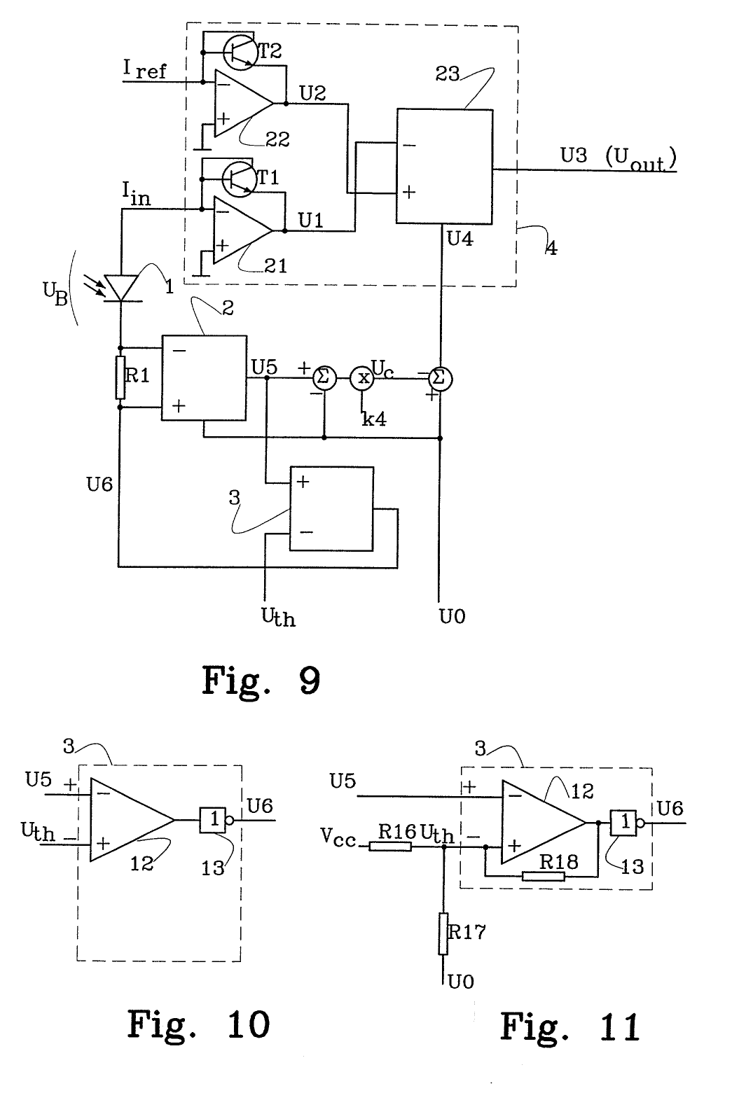

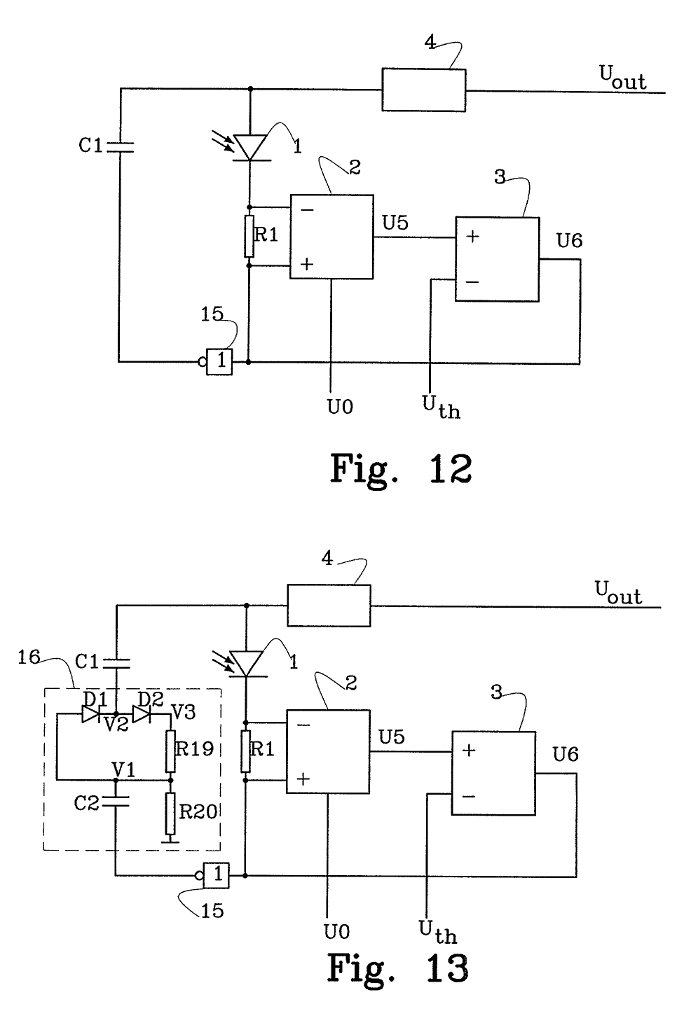

Now, there may be a wish to use the fifth voltage U5 also for other purposes than to create the compensation voltage U_{C}, which will be shown later in FIG. 9ff. In that case it may be a wish to create a fifth voltage U5 with a level adjustment with the level adjust voltage U0. This is shown in FIG. 6, where the level adjust voltage U0 is connected also to the second differential amplifier 2. In this case the compensation voltage should be created as:

U5=(R1·Iᵢₙ)·R7/R6+U0 (15)

U_{C}=(U5−U0)·k4=R1·R7/R6·k4·Iᵢₙ (16)

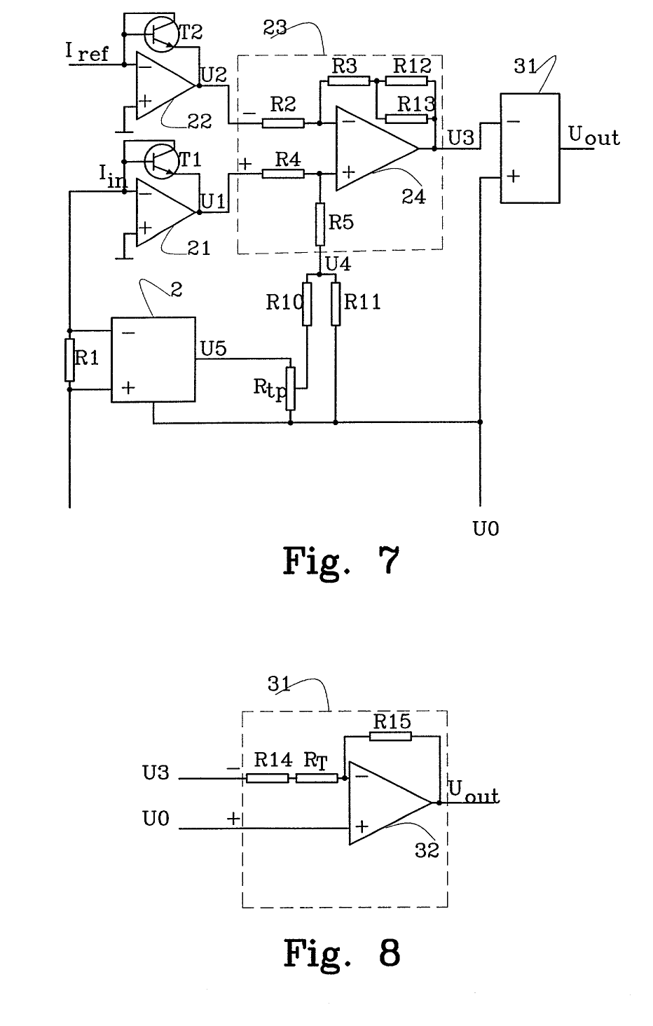

In FIG. 7 is shown a practical implementation of FIG. 6. To be able to trim the magnitude of the compensation voltage U_{C} a trimming potentiometer Rₜₚ is connected with its ends between the fifth voltage U5 and the level adjust voltage U0. A tenth resistor R10 is connected between the fourth voltage U4 and the middle connection of the trimming potentiometer Rₜₚ. A eleventh resistor R11 is connected between the fourth voltage U4 and the level adjust voltage U0.

To achieve the best result the third resistor R3 in the second differential amplifier 23 may then be complemented by a twelfth resistor R12 and a thirteenth resistor R13 in order to compensate for resistive influence of the tenth resistor R10 and the eleventh resistor R11.

The inverting amplifier 31 may be any inverting amplifier. However, even though the temperature dependence in the logarithmic amplifier partly is reduced by taking the difference between what is measured and a reference, there is still the second temperature dependency in the third voltage U3 that is proportional to the absolute temperature T in Kelvin. Thus, it would be good to include a circuit with a temperature dependency that is proportional to the inverse of the absolute temperature and the inverting amplifier 31 may be used for that purpose.

In FIG. 8 is shown an example of such an inverting amplifier. It includes a fifth operational amplifier 32 with a fourteenth resistor R14 on its negative input, with the level adjust voltage U0 on its positive input and a fifteenth resistor R15 between its negative input and its output. The use of only those resistors and with the third voltage U3 connected to the fourteenth resistor R14 would give an output voltage Uₒᵤₜ of:

Uₒᵤₜ=(U0−U3)·R15/R14+U0 (17)

Hence, if it were possible to find a fourteenth resistor R14 that varied as R14=R₀·T, where R₀ is a constant, then our problems would be solved. However, that proves difficult to find in practice. This can be solved by adding a temperature dependent resistor R_{T} in series, before or after, the fourteenth resistor R14. Said temperature dependent resistor R_{T} is preferably a PRTD, i.e., a Resistance Temperature Detector made of platinum. This type of resistor is very well characterized and standardized since it is normally used as a temperature sensor. The fourteenth resistor R14 and the fifteenth resistor R15 could then be normal resistors with no or at least low temperature dependency. Thus, the output voltage Uₒᵤₜ becomes:

Uₒᵤₜ=(U0−U3)·R15/(R14+R_{T})+U0 (18)

If as an example a PRTD with 1000Ω complying with the standard DIN EN 60751 according to IEC 751 is used and the fourteenth resistor R14 is chosen as 55.77Ω, then the maximum deviation within 0-70° C. will become approximately 0.2° C. In order to achieve this the temperature dependent resistor R_{T} should have approximately the same temperature as the transistors T1, T2. This is easiest implemented in practice if the temperature dependent resistor R_{T} and the transistors T1, T2 are placed close to each other and if the circuit is so dimensioned that the power in the temperature dependent resistor R_{T} is not so high that self-heating occurs.

In FIG. 9 is shown the particular case when then the input current Iᵢₙ is a photocurrent from a photodiode or phototransistor 1. The photodiode 1 is connected in series with the first resistor R1. The first resistor R1 may be connected either to the cathode or to the anode of the photodiode 1. However, since the anode is more sensitive it is preferred to connect the first resistor R1 to the cathode, as is shown in the figures. In FIG. 9 and following figures the logarithmic amplifier will be denoted with 4.

When a photodiode is used in circuits in prior art it is optimized either for high or low optical powers by using a constant bias voltage. As an example, if a photodiode of PIN-type is used and a low optical power, such as <1 μW, is to be measured, then the photodiode should have a bias voltage of 0 V. This is due to the fact that photodiodes when biased normally has a so called dark current which may disturb. The photodiode may also be seen as having a shunt resistance that conducts when the bias voltage is not 0 V and thus provides a current. The magnitude of said currents may be e.g., 25 nA at 70° C.

If on the other hand said photodiode is to measure a high optical power, such as >0,5 mW, the photodiode needs to be biased with e.g., 5 V or else the photodiode will become saturated and the photo current will thus become too small.

A disadvantage with known circuits for photodiodes is thus that the range of the optical power cannot be too wide. An example of an application where the optical power range is wide is in systems using wavelength division multiplexing (WDM). This means that signals are transmitted in a line divided into channels with different wavelengths. The signals are amplified on the way and sometimes it is wished to be able to measure the total optical power before or after amplification. The development is going towards more channels in the same line, which of course leads to a higher maximum optical power and thus an urgent need exists for something that may measure a wide optical power range.

This problem may be solved with the additional features in FIG. 9. The main idea is that said photocurrent Iᵢₙ is to be measured and compared to a threshold and that the photodiode 1 is given a bias voltage U_{B} depending on if the photocurrent Iᵢₙ is above or below said threshold. It is possible to measure the photocurrent Iᵢₙ directly and to compare it to a threshold current. However, voltages are easier to measure and compare and actually this is already done in FIG. 9—the fifth voltage U5. This is an example of when it may be good to have the fifth voltage U5 with a level adjustment.

The fifth voltage U5 is now compared with a threshold voltage Uₜₕ in a comparator 3, which then gives out a sixth voltage U6, which will affect the bias voltage U_{B}. The anode of the photodiode 1 is in this example connected to a voltage at ground level, so called virtual ground.

The fifth voltage U5 is connected to the positive input of the comparator 3 and the threshold voltage Uₜₕ is connected to the negative input of the comparator 3. Thus, if the fifth voltage U5 is greater than the threshold voltage Uₜₕ, then the sixth voltage U6 from the comparator 3 becomes high, e.g., 5 V. Thus, the bias voltage U_{B} in this case becomes a little less than 5 V. If, on the other hand, the fifth voltage U5 is smaller than the threshold voltage Uₜₕ, then the sixth voltage U6 from the comparator 3 becomes 0 V. Thus, the bias voltage U_{B} in this case becomes extremely close to 0 V. The magnitude of the high bias voltage is chosen to suit the particular photodiode 1 that is used, depending on its inner resistance. However, to simplify the description, the example 5 V will be used in the following.

If the voltage at the anode of the photodiode 1 should have another magnitude than virtual ground, then the values of the sixth voltage U6 given above should be changed accordingly to give the desired bias voltage U_{B}.

An advantage with the invention in FIG. 9 is that it is a photodiode bias circuit that works well when the photodiode is to measure low optical powers. This is because the bias voltage U_{B} in this case is 0 V, which minimizes both dark current and the effects of the shunt resistance and thus improves linearity. Further, the invention in FIG. 1 is also a photodiode bias circuit that works well when the photodiode is to measure high optical powers. This is because the photodiode in this case gets a bias voltage U_{B} of e.g., 5 V, which prevents the photodiode from becoming saturated too quickly and thus improves linearity. Thus, a photodiode bias circuit is achieved that works linearly in a wide optical power range.

In FIG. 10 is shown an embodiment of the comparator 3. It is difficult to find a commercial comparator that has a swing between 0 V and 5 V. When low optical powers are to be measured, the closer the bias voltage U_{B}, i.e., in this case also the sixth voltage U6, is to 0 V, the better, i.e., the more linear, this photodiode circuit will work. The sixth voltage U6 should in that case preferably not be higher than a few mV. Commercial comparators often have difficulties in getting that close to 0 V.

This can be solved with the embodiment in FIG. 10, where the comparator 3 includes an inverter 13 and an inner comparator 12 with a positive and a negative input and an output. The positive input of the inner comparator 12 is used as the negative input of the comparator 3 and vice versa, due to the following inverter 13. If the inverter 13 is e.g., of CMOS-type it will have the same logical output as its supply voltage. Thus if the inverter 13 is supplied with 0 V and 5 V, its output will change between 0 V and 5 V, which is exactly what is wanted. Note that the main issue is not that it is an inverter, but that it has the output that is wanted. The same result could be achieved with e.g., another CMOS-circuit or with a comparator with CMOS-type output.

A photodiode is normally sensitive to fast changes in its bias voltage, why it is a big advantage if the positive supply voltage to the inverter 13 is carefully filtered so that there are no disturbances on the output of the inverter 13.

If the fifth voltage U5 happens to be close to the threshold voltage Uₜₕ, frequent changes could occur in the sixth voltage U6 and thus in the bias voltage U_{B}. That is not desired. An improved solution would then be to introduce a hysteresis with two thresholds. This may e.g., be accomplished by using a comparator with a feedback, also called a Schmitt trigger. This is represented in FIG. 11. A sixteenth resistor R16 is connected between the power supply voltage V_{CC} and the positive input of the inner comparator 12. A seventeenth resistor R17 is connected between the level adjust voltage U0 and the positive input of the inner comparator 12. An eighteenth resistor R18 is connected between the positive input and the output of the inner comparator 12.

The threshold voltage Uₜₕ is created on the positive input of the inner comparator 12 with a level adjustment from the level adjust voltage U0. If the circuit should be arranged so that the threshold voltage Uₜₕ feeds the negative input of the inner comparator 12, then the positive input of the inner comparator 12 should be fed from a low-resistance source in order that the positive feedback is precisely determined, i.e., the resistances should be selected so that R17<<R18.

When then the connection is as in FIG. 11 and the output of the inner comparator 12 changes state, then the positive feedback has the effect of changing the threshold voltage Uₜₕ slightly so that a relatively large change of input signal is then required to reverse the output state.

It is possible to change the bias voltage both fast and slow. A photodiode have a certain capacitance between its anode and cathode. This leads to that when the voltage is changed over the photodiode, then a transient current is generated proportionally to the derivative of the voltage change. Thus, one would believe that it would be better to change the bias voltage slowly. However, if the bias voltage is changed slowly, then the total circuit will become slow and rapid changes in optical power will not be measured. Thus, the preferred embodiment is to change the bias voltage fast.

When the bias voltage is raised, then said transient current will have a rather small influence compared to the large photo current. Instead there will be a problem when the optical power and thus the bias voltage is lowered. That is because the charge between the cathode and the anode of the photodiode will totally cut-off the logarithmic amplifier. Thus, the logarithmic amplifier will consider that it is measuring total darkness and will do that until the photocurrent has restored the real charge.

A solution to this problem is shown in FIG. 12. A charge compensation capacitor C1 is introduced between the anode of the photodiode 1 and the output of the comparator 3 over a second inverter 15. The purpose is to generate a second transient current with the opposite sign as the first transient current produced by the photodiode 1 when the bias voltage is changed.

Preferably, the capacitance of the charge compensation capacitor C1 is somewhat larger than the capacitance of the photodiode 1. What will happen is then this: When the bias voltage U_{B} suddenly goes down to 0 V, then a first transient current will come out from the input of the logarithmic amplifier 4 through the photodiode. A few ns later a somewhat larger second transient current will be produced by the charge compensation capacitor C1 in the opposite direction. If the logarithmic amplifier 4 is normally slow it will only feel a small fast sum transient current in the right direction, i.e., into its input. This means that the output voltage Uₒᵤₜ will experience a fast positive transient and then regain its correct value without ever going below said correct value. Thus, the logarithmic amplifier 4 and subsequent circuits will never believe that it is dark simply because the bias voltage U_{B} suddenly is lowered.

In the simplest version there is simply a direct connection between the charge compensation capacitor C1 and the second inverter 15. This means that the charge compensation capacitor C1 always is connected with a low impedance to the second inverter 15. In certain applications this is a disadvantage. As an example may the bandwidth of the total circuit with photodiode and logarithmic amplifier become deteriorated due to the extra input capacitance from the charge compensation capacitor C1.

This may be solved by using an isolator 16 to isolate the charge compensation capacitor C1 from the second inverter 15 e.g., with the aid of diodes. The isolator may be implemented in numerous ways and one alternative is shown in FIG. 12. The man skilled in the art can easily adopt other versions with equivalent function.

A second capacitor C2 is on one end connected to the output of the second inverter 15 and on its other end, at the first potential V1, to the anode of a first diode, to a nineteenth resistor R19 and to a twentieth resistor R20. The twentieth resistor R20 is further connected to ground. The cathode of the first diode D1 is connected, at the second potential V2, to the charge compensation capacitor C1 and to the anode of a second diode D2. The cathode of the second diode D2 is further connected, at the third potential V3, to the nineteenth resistor R19.

In a status quo case the three potentials V1, V2, V3 will be 0 V since no currents are flowing. Further, the impedance over the isolator 16 will be high—with a low capacitance.

If the photocurrent Iᵢₙ decreases and the sixth voltage U6 goes down to 0 V, then the second inverter 15 will go high and the second capacitor C2 will be charged. Thus, the first potential V1 will become high and the first diode D1 starts to conduct, which means that the second potential V2 will become high. This in its turn will charge the charge compensation capacitor C1, which will discharge through the input of the logarithmic amplifier 4, as mentioned earlier.

The second capacitor C2 should be chosen with a higher capacitance than the charge compensation capacitor C1, because in that case the second capacitor C2 will discharge slower than the charge compensation capacitor C1. The second capacitor C2 discharges over the twentieth resistor R20 to ground. When it is completely discharged, the first potential V1 will once again become 0 V and the first diode D1 will stop conducting. The second potential V2 will discharge again over the second diode D2 and the nineteenth resistor R19. Thus, the status quo is once again reached.

If instead the photo current Iᵢₙ increases and thus the sixth voltage U6 increases and thus the second inverter goes low, then the second capacitor C2 will be charged and the first potential V1 will decrease to −5 V. The second capacitor C2 will then charge and discharge much like the previous example, but with the current in the opposite direction and the first potential will then return to 0 V.

A preferred embodiment is that the transient current from the charge compensation capacitor C1 should not be very high when the photo current Iᵢₙ is high, as explained above. In that case the resistances of the nineteenth resistor R19 and the twentieth resistor R20 should be rather high. That is because that leads to that only a small current flows from the second potential V2 to the first potential V1 over the second diode D2 and the nineteenth resistor R19. Thus, the charge compensation capacitor C1 is charged slower and a smaller transient current will occur.

In prior art it is common to filter away disturbances with strong low-pass-filtering, which gives the effect that the bandwidth is narrowed and thus that fast changes in the optical power cannot be measured. An advantage with the last embodiments of the present invention is that the automatic change of the bias voltage is so smooth that it is possible to have a high bandwidth without getting problems with disturbances.

A further advantage with this embodiment is that the same circuit—the second differential amplifier 2—may be used for two purposes, i.e., to create the bias voltage U_{B} for the photodiode and to create the compensation voltage U_{C}. This saves components and space and further reduces the time for manufacturing. However, it would be equally possible to have separate circuits for the two purposes.

The first resistor R1 may be connected either to the cathode or to the anode of the photodiode 1. However, since the anode is more sensitive it is preferred to connect the first resistor R1 to the cathode, as is shown in the figures.

Alternative and equivalent embodiments to those above arise if instead of the anode, the cathode of the photodiode is connected to the logarithmic amplifier. Then all the signs in the rest of the circuits would have to change. e.g., would the sixth voltage U6 then become −5 V at high optical powers.

1. Logarithmic amplifier for reading an input current (Iᵢₙ) or input voltage (Uᵢₙ) and for giving out an output voltage (Uₒᵤₜ), said logarithmic amplifier including a logarithmic element (T1) for generating logarithmic amplification, said logarithmic element (T1) including an inner serial resistance, characterized in that a compensation voltage (U_{C}) is arranged to be subtracted from the output voltage (Uₒᵤₜ) to compensate for voltage drop over the inner serial resistance.

2. Logarithmic amplifier according to claim 1, characterized in that the compensation voltage (U_{C}) is a function of the input current (Iᵢₙ) or input voltage (Uᵢₙ).

3. Logarithmic amplifier according to claim 1, characterized in that the logarithmic element (T1) is a transistor.

4. Logarithmic amplifier according to claim 1, characterized in that the logarithmic element (T1) is a diode.

5. Logarithmic amplifier according to claim 1, characterized in that a first differential amplifier (23) is provided with three inputs and an output, in that the first voltage (U1) is connected to the first input of the first differential amplifier (23), in that a second voltage (U2) proportional to a reference current (I_{ref}) is connected to the second input of the first differential amplifier (23), in that a fourth voltage (U4) proportional to the compensation voltage (U_{C}) is connected to the third input of the first differential amplifier and in that a third voltage (U3) related to the output voltage (Uₒᵤₜ) may be taken out from the output of the first differential amplifier (23).

6. Logarithmic amplifier according to claim 5, characterized in that an inverting amplifier (31) including a positive input, a negative input and an output is connected to the output of the second differential amplifier (23).

7. Logarithmic amplifier according to claim 6, characterized in that the inverting amplifier (31) includes a temperature dependent resistor (R_{T}) on its negative input.

8. Logarithmic amplifier according to claim 7, characterized in that the temperature dependent resistor (R_{T}) is a resistance temperature detector made of platinum.

9. Logarithmic amplifier according to claim 7, characterized in that a resistor (R19) with a resistance of 55.77Ω is connected in series with the temperature dependent resistor (R_{T}), and in that the temperature dependent resistor (R_{T}) has a resistance of 1000Ω.

10. Logarithmic amplifier according to claim 1, characterized in that a second differential amplifier (2) with at least two inputs and at least one output is connected with two of its inputs on each side of a first resistor (R1), in that the input current (Iᵢₙ) is arranged to flow through said first resistor (R1), and in that a fifth voltage (U5) related to the compensation voltage (U_{C}) is provided on the output of the second differential amplifier (2).

11. Logarithmic amplifier circuit including a logarithmic amplifier and a photodiode (1) producing a photocurrent (I_{P}) used as the input current (Iᵢₙ), said photodiode (1) being biased with a bias voltage (U_{B}) characterized in that the logarithmic amplifier is according to any one of the claims 1-10.

12. Logarithmic amplifier circuit according to claim 11, characterized in that the photodiode (1) is connected with its anode to the first resistor (R1).

13. Logarithmic amplifier circuit according to claim 11, characterized in that the logarithmic amplifier circuit further includes a comparator (3, 12) for comparing the fifth voltage (U5) with a threshold (Uₜₕ) and for biasing the photodiode (1) with a bias voltage (U_{B}) having a magnitude depending on whether the fifth voltage (U5) is larger than the threshold (Uₜₕ) or smaller.

14. Logarithmic amplifier circuit according to claim 13, characterized in that the bias voltage (U_{B}) has a first magnitude close to 0 V if the fifth voltage (U5) is smaller than the threshold and a second magnitude corresponding to a positive voltage, such as 5 V, if the fifth voltage (U5) is larger than the threshold.

15. Logarithmic amplifying method in a logarithmic amplifier including a logarithmic element (T1), such as a transistor or a diode, with an inner serial resistance, said method including reading an input current (Iᵢₙ) or an input voltage (Vᵢₙ) and giving out an output voltage (Vₒᵤₜ), characterized by compensating for voltage drop over the inner serial resistance by subtracting a compensation voltage (U_{C}) from the output voltage (Uₒᵤₜ).

16. Logarithmic amplifying method according to claim 15, characterized by creating the compensation voltage (U_{C}) as a function of the input current (Iᵢₙ).

17. Logarithmic amplifying method according to claim 15, wherein a photodiode (1) is producing a photocurrent used as the input current (Iᵢₙ), said photodiode (1) being biased with a bias voltage (U_{B}) characterized by using a fifth voltage (U5) to generate both the compensation voltage (U_{C}) and the bias voltage (U_{B}).

18. Logarithmic amplifying method according to claim 17, characterized by comparing the fifth voltage (U5) with a threshold (Uₜₕ) and giving the bias voltage (U_{B}) a magnitude depending on whether the fifth voltage (U5) is larger than the threshold (Uₜₕ) or smaller.

19. Logarithmic amplifying method according to claim 18, characterized by giving the bias voltage (U_{B}) a first magnitude close to 0 V if the fifth voltage (U5) is smaller than the threshold (Uₜₕ) and a second magnitude corresponding to a positive voltage, such as 5 V, if the fifth voltage (U5) is larger than the threshold (Uₜₕ).
